(19) United States
(12) Patent Application Publication
(10) Pub. No.: US 2026/0009339 A1
(43) Pub. Date: Jan. 8, 2026

(54) CANTILEVER STATOR VANE

(71) Applicant: Pratt & Whitney Canada Corp., Longueuil (CA)

(72) Inventors: Hien Duong, Mississauga (CA); Jacob Zilli, Milton (CA)

(21) Appl. No.: 18/762,968

(22) Filed: Jul. 3, 2024

(51) Int. Cl. F01D 9/04

(52) U.S. Cl. CPC F01D 9/041; F05D 2220/323; F05D 2230/60; F05D 2240/124; F05D 2250/712

(57) ABSTRACT

A stator vane is provided and includes an airfoil section. The airfoil section includes a leading edge, a trailing edge opposite the leading edge, a pressure side extending from the leading edge to the trailing edge and a suction side opposite the pressure side and extending from the leading edge to the trailing edge. The pressure and suction sides form a whale-shaped forward portion proximate to the leading edge. The suction side forms a reverse-turning section proximate to the trailing edge.

### BACKGROUND

The present disclosure relates to gas turbine engines and, more particularly, to cantilever stator vanes of a gas turbine engine.

A gas turbine engine for use in subsonic flight generally includes a fan through which ambient air is propelled, a compressor for pressurizing the air, a combustor in which the compressed air is mixed with fuel and ignited for generating an annular stream of hot combustion gases and a turbine section for extracting energy from the combustion gases. The compressor section and the turbine section can each include rotor and stator vane stages where the rotor stages within the compressor section and the rotor stages within the turbine section rotate about a rotational axis.

Each rotor stage can include a hub with rotor blades extending radially outwardly from the hub. A compressor section may include one or more stator vane stages, each including circumferentially arranged stator vanes. The stator vanes can extend radially between inner and outer gas path structures that define a gas flow path. The stator vanes are typically configured to direct airflow into a rotor stage or to direct airflow exiting a rotor stage.

Compressor stator vanes can be shrouded stator vanes, which are bounded at both ends, or cantilever stator vanes that each have an airfoil section that extends from a shroud to a hub and features a radial gap at one end. Shrouded stator vanes are typically stiffer and less prone to failure triggered by aerodynamically induced vibration. Cantilevered stator vanes are easier to manufacture and have some aerodynamic benefits, particularly when the radial gap is small. Often, frontward stator vane stages with high aspect ratios have shrouded designs whereas later stages can have cantilever designs.

### BRIEF DESCRIPTION

According to an aspect of the disclosure, a stator vane is provided and includes an airfoil section. The airfoil section includes a leading edge, a trailing edge opposite the leading edge, a pressure side extending from the leading edge to the trailing edge and a suction side opposite the pressure side and extending from the leading edge to the trailing edge. The pressure and suction sides form a whale-shaped forward portion proximate to the leading edge. The suction side forms a reverse-turning section proximate to the trailing edge.

In accordance with additional or alternative embodiments, the whale-shaped forward portion forms a maximum thickness of the airfoil section with a maximum thickness/chord ratio of about 8-20%.

In accordance with additional or alternative embodiments, the whale-shaped forward portion includes locally thickened sections of the pressure side and the suction side from about 15-45% chord length.

In accordance with additional or alternative embodiments, the reverse-turning section includes a concave section of the suction side.

In accordance with additional or alternative embodiments, the reverse-turning section starts at about 70%-85% of a chord of the airfoil section and extends to the trailing edge.

In accordance with additional or alternative embodiments, a reverse turning degree of the reverse-turning section is up to about 10 degrees.

In accordance with additional or alternative embodiments, the whale-shaped forward portion and the reverse-turning section are provided between about 5-25% span.

In accordance with additional or alternative embodiments, the whale-shaped forward portion forms a maximum thickness of the airfoil section with a maximum thickness/chord ratio of about 8-20% and includes locally thickened sections of the pressure side and the suction side from about 15-45% chord length and the reverse-turning section includes a concave section of the suction side, starts at about 70%-85% of a chord of the airfoil section, extends to the trailing edge and has a reverse turning degree of up to about 10 degrees.

According to an aspect of the disclosure, a compressor section of an aircraft gas turbine engine is provided and includes an inner gas path structure, an outer gas path structure disposed about the inner gas path structure and a stator stage. The stator stage includes a plurality of cantilever stator vanes. Each cantilever stator vane of the plurality of the cantilever stator vanes includes an airfoil section. The airfoil section includes a leading edge, a trailing edge opposite the leading edge, a pressure side extending from the leading edge to the trailing edge, a suction side opposite the pressure side and extending from the leading edge to the trailing edge, a tip connected to the outer gas path structure and a base end cantilevered from the inner gas path structure. The pressure and suction sides form a whale-shaped forward portion proximate to the leading edge. The suction side forms a reverse-turning section proximate to the trailing edge.

In accordance with additional or alternative embodiments, the whale-shaped forward portion of the airfoil section forms a maximum thickness of the airfoil section with a maximum thickness/chord ratio of about 8-20%.

In accordance with additional or alternative embodiments, the whale-shaped forward portion of the airfoil section includes locally thickened sections of the pressure side and the suction side from about 15-45% chord length.

In accordance with additional or alternative embodiments, the reverse-turning section of the airfoil section includes a concave section of the suction side.

In accordance with additional or alternative embodiments, the reverse-turning section of the airfoil section starts at about 70%-85% of a chord of the airfoil section and extends to the trailing edge.

In accordance with additional or alternative embodiments, a reverse turning degree of the reverse-turning section is up to about 10 degrees.

In accordance with additional or alternative embodiments, the whale-shaped forward portion and the reverse-turning section of the airfoil section are provided at about 5-25% span, the whale-shaped forward portion of the airfoil section forms a maximum thickness of the airfoil section with a maximum thickness/chord ratio of about 8-20% and includes locally thickened sections of the pressure side and the suction side from about 15-45% chord length and the reverse-turning section of the airfoil section includes a concave section of the suction side, starts at about 70%-85% of a chord of the airfoil section, extends to the trailing edge and has a reverse turning degree of up to about 10 degrees.

According to an aspect of the disclosure, a method of fabricating a cantilever stator vane including an airfoil section to be affixed to an outer gas path structure of a compressor section of an aircraft gas turbine engine with a radial base cantilevered from an inner gas path structure opposite the outer gas path structure is provided. The method includes arranging pressure and suction sides of the airfoil section to form a whale-shaped forward portion proximate to a leading edge of the airfoil section and arranging the suction side to form a reverse-turning section proximate to a trailing edge of the airfoil section.

In accordance with additional or alternative embodiments, the arranging of the pressure and suction sides of the airfoil section are executed to form the whale-shaped forward portion proximate to the leading edge of the airfoil section at about 5-25% span and the arranging of the suction side is executed to form the reverse-turning section proximate to the trailing edge of the airfoil section at about 5-25% span.

In accordance with additional or alternative embodiments, the arranging of the pressure and suction sides of the airfoil section to form the whale-shaped forward portion is executed such that the whale-shaped forward portion forms a maximum thickness of the airfoil section with a maximum thickness/chord ratio of 8-20%.

In accordance with additional or alternative embodiments, the arranging of the pressure and suction sides of the airfoil section to form the whale-shaped forward portion is executed such that the whale-shaped forward portion includes locally thickened sections of the pressure and suction sides from about 15-45% chord length.

In accordance with additional or alternative embodiments, the arranging of the suction side to form the reverse-turning section is executed such that the reverse-turning section includes a concave section of the suction side and starts about 70%-85% of a chord of the airfoil section.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

For a more complete understanding of this disclosure, reference is now made to the following brief description, taken in connection with the accompanying drawings and detailed description, wherein like reference numerals represent like parts:

FIG. 1A is a side schematic illustration of a gas turbine engine for use in an aircraft in accordance with embodiments;

FIG. 1B is an enlarged side schematic illustration of a portion of the gas turbine engine of FIG. 1 in accordance with embodiments;

FIG. 2 is a perspective view of a cantilevered stator vane of a compressor stator stage of a compressor section of the gas turbine engine of FIG. 1 in accordance with embodiments;

FIG. 3 is a graphical illustration of a configuration of a whale-shaped forward portion and a reverse-turned portion of the cantilevered stator vane of FIG. 2 in accordance with embodiments;

FIG. 4 is a graphical depiction of surface Mach number difference between a baseline design and the cantilevered stator vane of FIGS. 2 and 3 in which a location of maximum delta in the surface Mach number also is an indication of a location of a peak pressure differential between suction and pressure surfaces in accordance with embodiments;

FIG. 5 is a graphical depiction of a maximum thickness of the cantilevered stator vane of FIGS. 2 and 3 in comparison with a baseline design in accordance with embodiments;

FIG. 6 is a graphical illustration of a region of peak pressure differential and a lower pressure of the cantilevered stator vane of FIGS. 2 and 3 in comparison with a baseline design in accordance with embodiments;

FIG. 7 is a graphical illustration of reduced losses of the cantilevered stator vane of FIGS. 2 and 3 in comparison with a baseline design in accordance with embodiments;

FIG. 8 is a graphical illustration of reduced wakes of the cantilevered stator vane of FIGS. 2 and 3 in comparison with a baseline design in accordance with embodiments; and

FIG. 9 is a flow diagram illustrating a method of fabricating a cantilevered stator vane in accordance with embodiments.

### DETAILED DESCRIPTION

Cantilever stator vanes can have improved performance compared to shrouded stator vanes due to hub clearance flows that oppose near-wall low-momentum cross flows. This can be due to the fact that cross-secondary flows cannot accumulate at suction side corners, which, in turn, tends not to evoke high-loss corner separation phenomena such that loss-rich corner separation is suppressed. Since a rotating hub wall can migrate some leakage flow away from the suction side of stator vanes while energizing hub boundary layers, it has been found that, cantilevered stator vanes usually feature large clearances that avoid blade failures by rub-in events. Therefore, at design operating conditions, a stronger and more pronounced leakage flow tends to be present with cantilevered stator vanes and this can be accompanied by a corresponding increase in overall losses.

With the above in mind, in exemplary cases of conventional cantilever stator vane designs, a hub static pressure contour can have a peak pressure differential that is relatively close to the mid-chord where leakage flow tends to roll up into a vortex and mix with main flows before being swept downstream. This can lead to large mixing losses, especially where the Mach number at the hub is relatively high.

Thus, as will be described below, a cantilever stator vane is provided to minimize cantilever stator hub leakage flow under large clearances while improving performance and operating ranges for cantilever stator vanes. This is achieved by shaping a pressure side thickness and a suction side curvature distribution. In greater detail, since leakage flow is driven mainly by a pressure differential across a gap from a pressure side to a suction side of a cantilever stator vane, the cantilever stator vane described herein maximizes suction side pressure while minimizing pressure side pressure. The suction side of the cantilever stator vane is front loaded with increased turning and diffusion to gain pressure, while flow on the pressure side of the cantilever stator vane is accelerated with front thickness increase to reduce pressure. An under turning (reverse turning) section is shaped toward the trailing edge of the cantilever stator vane to further reduce leakage flow and to clean up and build up the boundary layer.

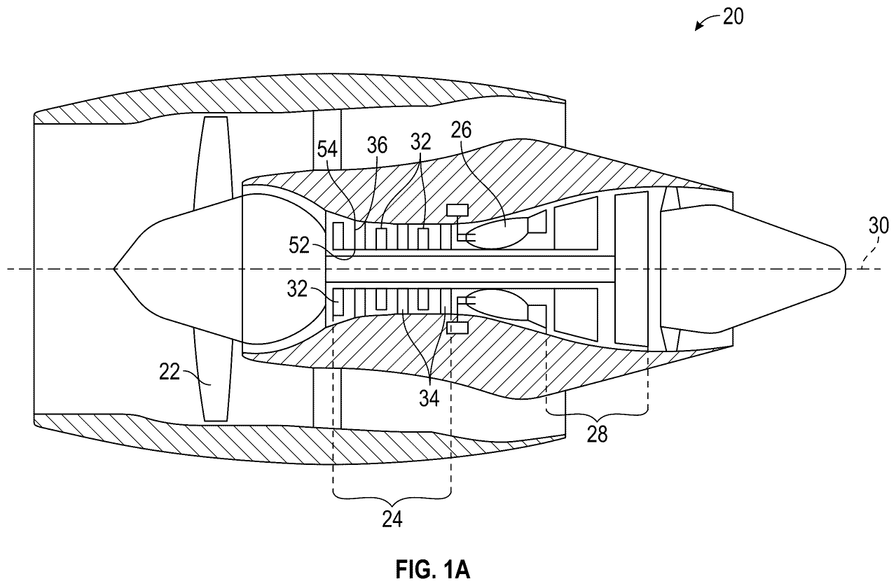

With reference to FIGS. 1A and 1B, a gas turbine engine 20 of a type provided for use in subsonic flight is provided. The gas turbine engine 20 includes in serial flow communication a fan 22 through which ambient air is propelled, a compressor section 24 for pressurizing the air, a combustor 26 in which the compressed air is mixed with fuel and ignited for generating an annular stream of hot combustion gases and a turbine section 28 for extracting energy from the combustion gases. The gas turbine engine 20 example shown in FIG. 1A is a two-spool turbofan rotating about a rotational axis 30. The present disclosure is not limited to use with two spool turbofan engines. In addition, the gas turbine engine example shown in FIG. 1 is shown as having spools rotating about the same rotational axis. The present disclosure is not limited to use with gas turbine engines having a plurality of spools rotating about the same rotational axis. It should be understood that the concepts described herein may be applied to a variety of gas turbine engine architectures, including gas turbine engines having geared architectures.

The compressor section 24 may include a single compressor section or more than one compressor section (e.g., a low pressure compressor and a high pressure compressor). To facilitate the description herein, the compressor section 24 will be described below in terms of a single compressor section, but the present disclosure is not limited thereto. The compressor section 24 may include one or more axial compressor rotor stages 32 and one or more compressor stator stages 34 that may be located immediately downstream of a compressor rotor stage 32. It should be noted that the terms “upstream” and “downstream” used herein refer to the direction of an air/gas flow passing through an annular gas path of the gas turbine engine 20. It should also be noted that the terms “radial” and “circumferential” are used herein with respect to the longitudinal rotational axis 30 of the gas turbine engine 20. Each compressor rotor stage 32 includes a hub with a plurality of rotor blades extending radially outward from the hub and distributed around the circumference of the compressor rotor stage and each compressor rotor stage 32 is configured to rotate about the rotational axis 30 of the gas turbine engine 20 to perform work on the air.

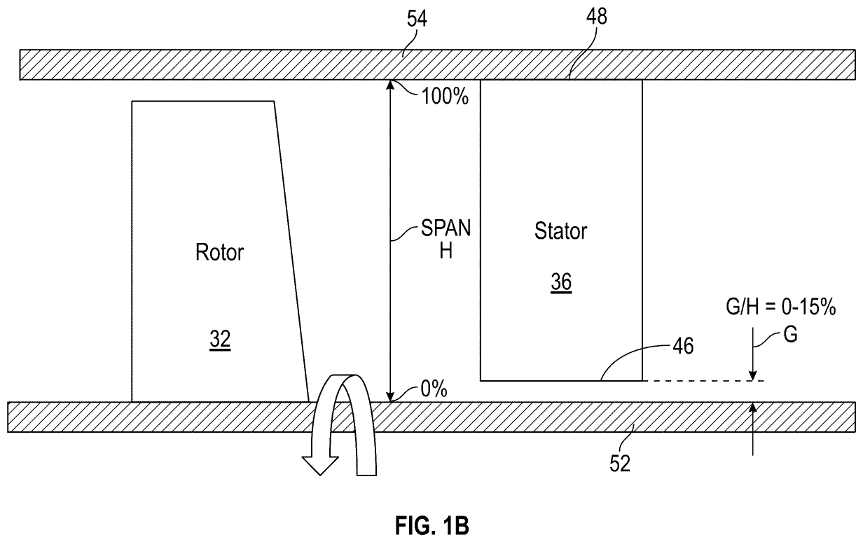

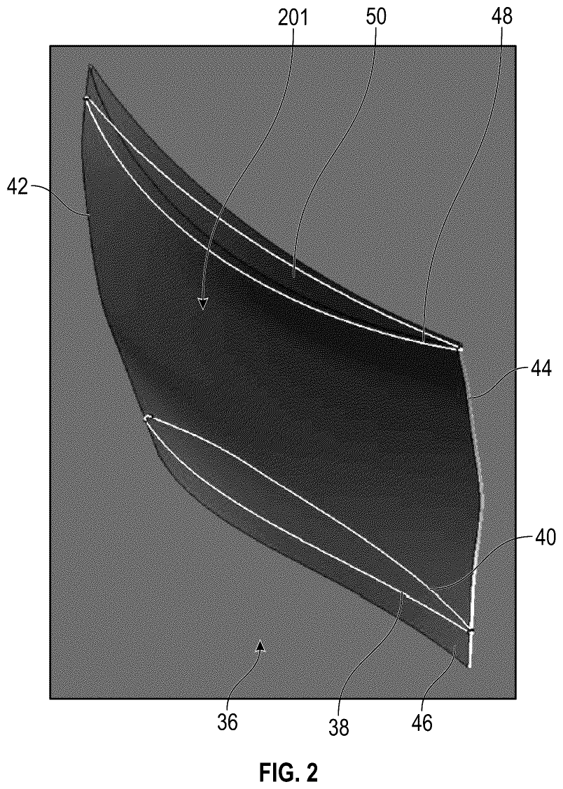

With continued reference to FIGS. 1A and 1B and with additional reference to FIGS. 2 and 3, each compressor stator stage 34 is a non-rotating component that may guide the flow of pressurized air towards or away from a compressor rotor stage 32. Each compressor stator stage 34 has a plurality of stator vanes 36. Each stator vane 36 is configured to diffuse the airflow impinging thereon and to redirect the airflow (e.g., toward the next downstream compressor rotor stage 32).

As shown in FIGS. 2 and 3, each stator vane 36 has an airfoil-shaped body 201 having a suction side surface 38, a pressure side surface 40, a leading edge 42, a trailing edge 44, a radial base end 46, a vane tip 48 and a vane tip surface 50 disposed at the vane tip 48. Typically, each stator vane 36 is solid with continuous material between the suction side surface 38 and the pressure side surface 40 and with no internal voids other than as described herein although it is to be understood that this is not required and that embodiments exist in which one or more stator vanes 36 have internal voids (e.g., for cooling). A chord length or chord line 301 of the airfoil-shaped body 201 is defined between the leading edge 42 and the trailing edge 44. The suction side surface 38 and the pressure side surface 40 extend chordwise between the leading edge 42 and the trailing edge 44 and radially (also referred to as “spanwise”) between. In some embodiments, a compressor stator stage 34 may include an annular shroud structure that defines the outer gas path structure 54. The present disclosure is not limited to any particular outer gas path structure 54. The inner gas path structure 52 and the outer gas path structure 54 define an annular gas path through the compressor stator stage 34. The stator vanes 36 in the compressor stator stages 34 are typically spaced equidistantly from one another around the circumference of the stator vane stage 34. FIG. 1 illustrates compressor stator stages 34, each having a plurality of stator vanes 36 that are positionally fixed. Other compressor stator stage 34 embodiments may include stator vanes 36 that are pivotally mounted to permit the vanes 36 to be rotated relative to the incidence angle of airflow entering the compressor stator stage 34.

With continued reference to FIGS. 1A and 1B and to FIGS. 2 and 3, the compressor section 24 of the gas turbine engine 20 includes the inner gas path structure 52, the outer gas path structure 54, which is disposed about the inner gas path structure 52, compressor rotor stages 32 and compressor stator stages 34 interleaved with the compressor rotor stages 32. The compressor rotor stages 32 and the compressor stator stages 34 can be provided and configured generally as described above. In particular, each compressor stator stage 34 includes a plurality of stator vanes 36 (which can be configured as cantilevered stator vanes and will hereinafter be referred to as “cantilever stator vanes 36”). Each cantilever stator vane 36 includes the airfoil shaped body (hereinafter referred to as an “airfoil section”) 201 that is affixed to the outer gas path structure 54 and includes the leading edge 42, the trailing edge 44 opposite the leading edge 42, the pressure side surface 40 extending from the leading edge 42 to the trailing edge 44, the suction side surface 38 opposite the pressure side surface 40 and extending from the leading edge 42 to the trailing edge 44 and the vane tip 48. The vane tip 48 is connected to the outer gas path structure 54 and the radial base end 46 is displaced from and cantilevered off of the inner gas path structure 52. The displacement of the base end 46 off of the inner gas path structure 52 can be at about 0-15% span.

In accordance with embodiments and as shown in FIG. 3 in particular, the pressure side surface 40 and the suction side surface 38 of the airfoil section 201 cooperatively form a whale-shaped forward portion 310, which is proximate to the leading edge 42, and the suction side surface 38 of the airfoil section 201 forms a reverse-turning section 320, which is proximate to the trailing edge 44. The whale-shaped forward portion 310 of the airfoil section 201 can be disposed between about 5-25% span and includes locally thickened sections 311, 312 of the pressure side surface 40 and the suction side surface 38, respectively, and is thus effectively formed by the pressure side surface 40 and the suction side surface 38 respectively diverging in opposite directions from the chord line 301 near to the leading edge 42. The whale-shaped forward portion 310 forms a maximum thickness T of the airfoil section 201 with a maximum thickness/chord ratio of about 8-20% from about 15-45% chord length (i.e., where the leading edge 42 is at 0% chord length and the trailing edge 44 is at 100% chord length). The reverse-turning section 320 of the airfoil section 201 can be disposed between about 5-25% span and includes a concave section 321 of the suction side surface 38 and starts at about 75% of the chord line 301 of the airfoil section 201 and extends to the trailing edge 44. A degree of the reverse turning of the reverse-turning section 320 can be up to about 10 degrees. With the airfoil section 201 including the whale-shaped forward portion 310 and the reverse-turning section 320, the rest of the airfoil section 201 can be thickened to blend back from max thickness to the leading and trailing edge thicknesses.

It is to be understood that 0% span is defined at the inner gas path structure 52 and 100% span is defined at the outer gas path structure 54 with the displacement of the base end 46 off of the inner gas path structure 52 being at about 0-15% span.

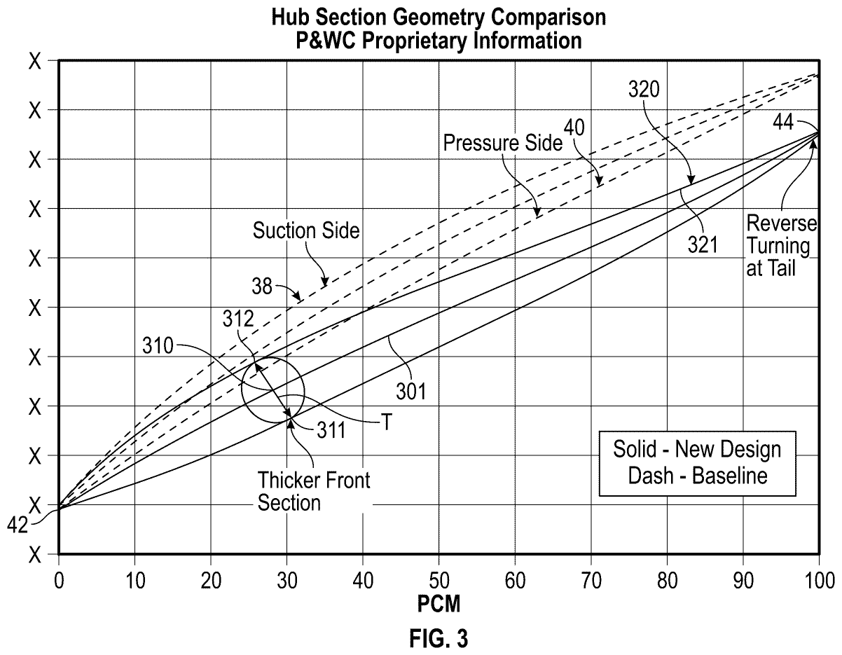

With reference to FIG. 4, the cantilever stator vane 36 described herein exhibits at about the 5-25% span a peak pressure differential that is moved forwardly toward the leading edge 42 as well as a reduced pressure differential in comparison with a baseline configuration. The peak pressure reduction can be about 1-5% and the location of the peak pressure differential along a meridional chord can be about 25%-50%. This can result in decreased losses.

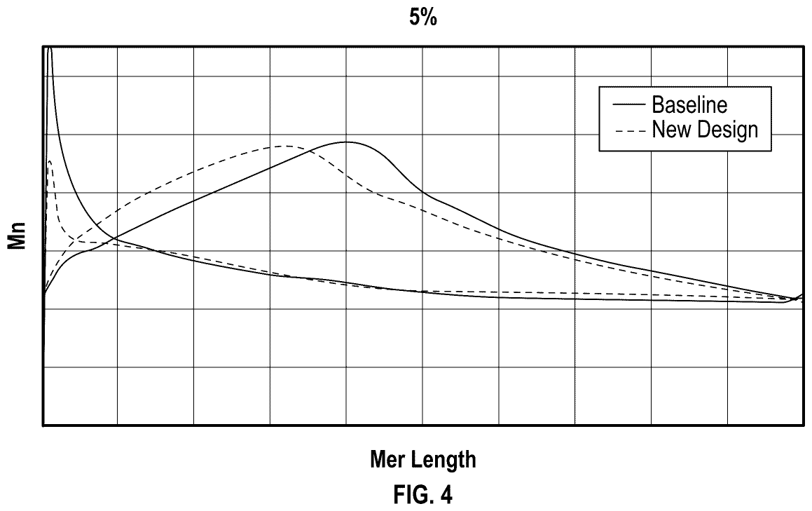

With reference to FIG. 5, the whale-shaped forward portion 310 of the cantilever stator vane 36 described herein forms the maximum thickness T of the airfoil section 201 with a maximum thickness/chord ratio of about 8-20% from about 15-45% chord length.

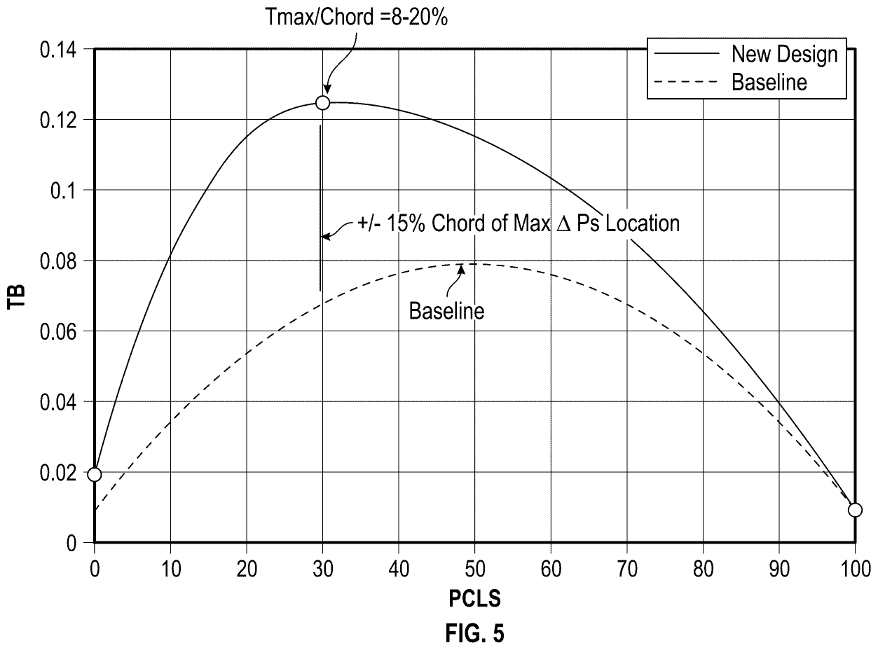

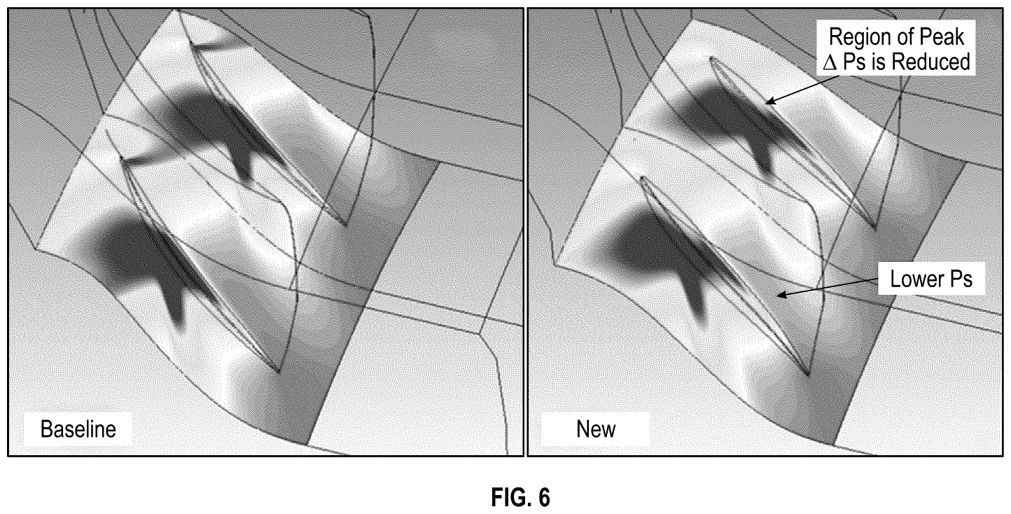

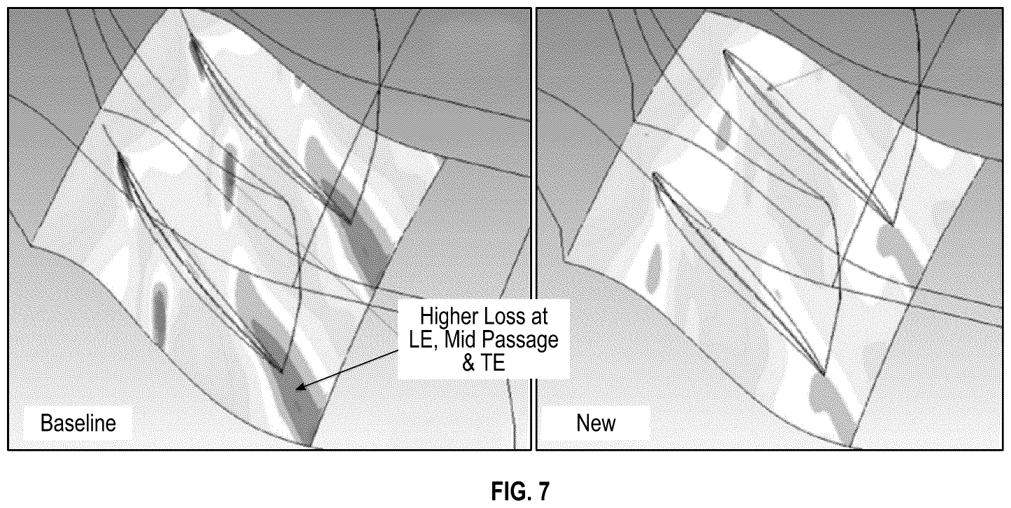

With reference to FIGS. 6-8, the airfoil section 201 of the cantilever stator vane 36 described herein exhibits further advantages especially in comparison with a baseline design. For example, as shown in FIG. 6, the airfoil section 201 exhibits a reduced region of peak pressure differential as well as lower maximum pressures as compared to the baseline design. As another example, as shown in FIG. 7, the airfoil section 201 exhibits reduced losses at the leading edge, at the mid-passage and at the trailing edge as compared to the baseline design. As yet another example, as shown in FIG. 8, the airfoil section 201 exhibits a reduced and narrowed wake as compared to the baseline design.

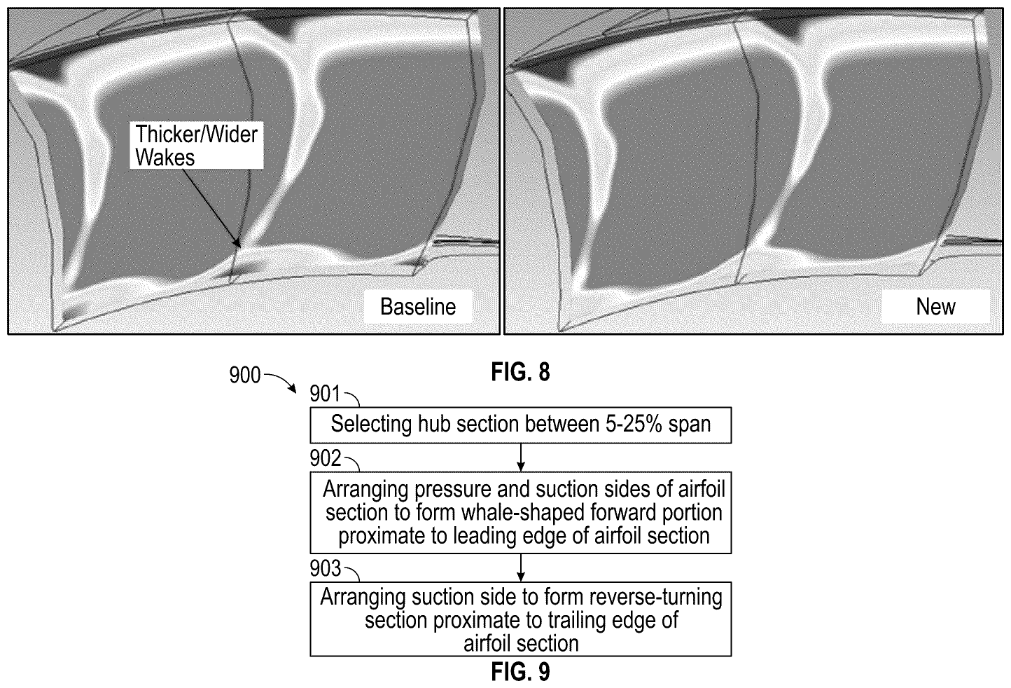

With reference to FIG. 9, a method 900 of fabricating a cantilever stator vane generally as described herein is provided. The method 900 includes selecting a hub section of the airfoil section between about 5-25% span, arranging pressure and suction sides of the airfoil section to form a whale-shaped forward portion proximate to a leading edge of the airfoil section (block 902) and arranging the suction side to form a reverse-turning section proximate to a trailing edge of the airfoil section (block 903).

Technical effects and benefits of the present disclosure are the provision of a cantilever stator vane that offers improved performance over conventional designs. Currently, reductions in hub leakage flows are achieved by either reducing hub turning, increasing blade counts or closing radial gaps. It has been found, however, that reducing turning may compromise performances of other stages, increasing blade counts may reduce overall losses but will increase cost and weight with potential structural issues and closing radial gaps risks rubbing incidents at other operating conditions. The new proposed design on the other hand improves performance, should fit in the same design spaces and costs the same with a minimal weight increase and potential for structure risks.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the technical concepts in the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

While the preferred embodiments to the disclosure have been described, it will be understood that those skilled in the art, both now and in the future, may make various improvements and enhancements which fall within the scope of the claims which follow. These claims should be construed to maintain the proper protection for the disclosure first described.

What is claimed is:

1. A stator vane, comprising:
an airfoil section, the airfoil section comprising:
a leading edge;
a trailing edge opposite the leading edge;
a pressure side extending from the leading edge to the trailing edge; and
a suction side opposite the pressure side and extending from the leading edge to the trailing edge,
the pressure and suction sides forming a whale-shaped forward portion proximate to the leading edge, and
the suction side forming a reverse-turning section proximate to the trailing edge.

2. The stator vane according to claim 1, wherein the whale-shaped forward portion forms a maximum thickness of the airfoil section with a maximum thickness/chord ratio of about 8-20%.

3. The stator vane according to claim 1, wherein the whale-shaped forward portion comprises locally thickened sections of the pressure side and the suction side from about 15-45% chord length.

4. The stator vane according to claim 1, wherein the reverse-turning section comprises a concave section of the suction side.

5. The stator vane according to claim 4, wherein the reverse-turning section starts at about 70%-85% of a chord of the airfoil section and extends to the trailing edge.

6. The stator vane according to claim 1, wherein a reverse turning degree of the reverse-turning section is up to about 10 degrees.

7. The stator vane according to claim 1, wherein the whale-shaped forward portion and the reverse-turning section are provided between about 5-25% span.

8. The stator vane according to claim 7, wherein:
the whale-shaped forward portion forms a maximum thickness of the airfoil section with a maximum thickness/chord ratio of about 8-20% and comprises locally thickened sections of the pressure side and the suction side from about 15-45% chord length, and
the reverse-turning section comprises a concave section of the suction side, starts at about 70%-85% of a chord of the airfoil section, extends to the trailing edge and has a reverse turning degree of up to about 10 degrees.

9. A compressor section of an aircraft gas turbine engine, comprising:
an inner gas path structure;
an outer gas path structure disposed about the inner gas path structure; and
a stator stage comprising a plurality of cantilever stator vanes, each of which comprises an airfoil section comprising:
a leading edge;
a trailing edge opposite the leading edge;
a pressure side extending from the leading edge to the trailing edge;
a suction side opposite the pressure side and extending from the leading edge to the trailing edge;
a tip connected to the outer gas path structure; and
a base end cantilevered from the inner gas path structure,
the pressure and suction sides forming a whale-shaped forward portion proximate to the leading edge, and
the suction side forming a reverse-turning section proximate to the trailing edge.

10. The compressor section according to claim 9, wherein the whale-shaped forward portion of the airfoil section forms a maximum thickness of the airfoil section with a maximum thickness/chord ratio of about 8-20%.

11. The compressor section according to claim 9, wherein the whale-shaped forward portion of the airfoil section comprises locally thickened sections of the pressure side and the suction side from about 15-45% chord length.

12. The compressor section according to claim 9, wherein the reverse-turning section of the airfoil section comprises a concave section of the suction side.

13. The compressor section according to claim 12, wherein the reverse-turning section of the airfoil section starts at about 70%-85% of a chord of the airfoil section and extends to the trailing edge.

14. The compressor section according to claim 9, wherein a reverse turning degree of the reverse-turning section is up to about 10 degrees.

15. The compressor section according to claim 9, wherein:
the whale-shaped forward portion and the reverse-turning section of the airfoil section are provided at about 5-25% span,
the whale-shaped forward portion of the airfoil section forms a maximum thickness of the airfoil section with a maximum thickness/chord ratio of about 8-20% and comprises locally thickened sections of the pressure side and the suction side from about 15-45% chord length, and
the reverse-turning section of the airfoil section comprises a concave section of the suction side, starts at about 70%-85% of a chord of the airfoil section, extends to the trailing edge and has a reverse turning degree of up to about 10 degrees.

16. A method of fabricating a cantilever stator vane comprising an airfoil section to be affixed to an outer gas path structure of a compressor section of an aircraft gas turbine engine with a radial base cantilevered from an inner gas path structure opposite the outer gas path structure, the method comprising:
arranging pressure and suction sides of the airfoil section to form a whale-shaped forward portion proximate to a leading edge of the airfoil section, and
arranging the suction side to form a reverse-turning section proximate to a trailing edge of the airfoil section.

17. The method according to claim 16, wherein:
the arranging of the pressure and suction sides of the airfoil section are executed to form the whale-shaped forward portion proximate to the leading edge of the airfoil section at about 5-25% span, and
the arranging of the suction side is executed to form the reverse-turning section proximate to the trailing edge of the airfoil section at about 5-25% span.

18. The method according to claim 17, wherein the arranging of the pressure and suction sides of the airfoil section to form the whale-shaped forward portion is executed such that the whale-shaped forward portion forms a maximum thickness of the airfoil section with a maximum thickness/chord ratio of 8-20%.

19. The method according to claim 17, wherein the arranging of the pressure and suction sides of the airfoil section to form the whale-shaped forward portion is executed such that the whale-shaped forward portion comprises locally thickened sections of the pressure and suction sides from about 15-45% chord length.

20. The method according to claim 17, wherein the arranging of the suction side to form the reverse-turning section is executed such that the reverse-turning section comprises a concave section of the suction side and starts at about 70%-85% of a chord of the airfoil section.
